(19) United States
(12) Patent Application Publication
(10) Pub. No.: US 2005/0279613 A1
(43) Pub. Date: Dec. 22, 2005

(54) Apparatus for automatically collecting and transporting objects

(75) Inventors: Jared Ezra Ufland, Los Angeles, CA (US); Luis Montano Vargas, Sun Valley, CA (US)

Correspondence Address: MORRISON & FOERSTER, LLP, 555 WEST FIFTH STREET, SUITE 3500, LOS ANGELES, CA, 90013-1024, US

(73) Assignee: National Conveyor Corp., Commerce, CA (US)

(21) Appl. No.: 11/159,658

(22) Filed: Jun. 22, 2005

Related U.S. Application Data
(60) Provisional application No. 60/582,249, filed on Jun. 22, 2004.

(51) Int. Cl. B65G 29/00

(52) U.S. Cl. 198/465.4

(57) ABSTRACT

The present invention is directed to a vertical displacement conveyor system for collecting and transporting objects, such as food trays, from a drop-off area to a receiving area. The conveyor system follows a vertical planar path, thereby allowing the drop-off area and the receiving area to be set at different elevations or at the same elevation and providing a smaller space footprint. The present invention is also directed to a vertical conveyor system for transporting and displaying object, such as bottles. A basket holding bottles is coupled to the conveyor system and then is transported in planar path for display.

### CROSS-REFERENCE TO RELATED APPLICATIONS

This application claims priority to U.S. provisional application Ser. No. 60/582,249 entitled “Apparatus for Automatically Collecting and Transporting Objects,” filed Jun. 22, 2004, the contents of which are incorporated herein by reference in its entirety for all purposes.

### BACKGROUND OF THE INVENTION

1. Field of Invention

The present invention is directed to an apparatus for automatically collecting and transporting objects such as food-carrying trays or cafeteria trays, wherein the trays can be efficiently and quickly collected at a designated drop-off area and transported to a designated receiving location via a transportation route that is at least in part vertically above or below the drop-off area.

2. Description of Related Art

In a self-service cafeteria or a restaurant setting in which food items and food wares are served on a tray, such as a standard 14 inches by 18 inches cafeteria tray, and in which the patrons are asked to return the trays to a designated drop-off location, it is well known in the art that conveyor systems may be employed to automatically pick up and transport the returned trays from the drop-off location to a receiving location, where employees of the cafeteria or the restaurant can pick up the dropped off trays and remove the soiled ware from the trays. In order to effect such an automatic system, a conveyor system using a rotating conveyor belt is typically used to transport the trays laterally from one location to the other.

FIG. 1A of the present application illustrates a top view of a lateral movement conveyor system. Specifically, FIG. 1A shows a lateral movement conveyor system 1 in which tray carriers 2 move laterally along a motorized conveyor system in a circular direction (as indicated by the arrows), rotating around a common wall 3 that separates the cafeteria or restaurant area 4 from the dish room 5, where the trays are off loaded and cleaned. As shown in FIG. 1A, patrons carrying food trays can drop off the trays at a drop-off window 6. The moving tray carrier then carries the dropped off food tray from the drop-off window 6 around the common wall 3 to the other side for off loading. As discussed above, a typical food tray measures 14 inches by 18 inches. The tray carriers 2 shown in FIG. 1A are preferably sufficiently deep and wide so as to be able to receive trays that are loaded in either orientation (i.e., either side ways or long ways).

In accordance with a more conventional type of conveyor system, the tray carriers are not employed; instead, a simple conveyor belt is used to transport the trays from the drop-off location to the receiving area. In the more conventional system where simply the conveyor belt is used, the belts or at least the transport canal on which the belt travels must be sufficiently wide to accommodate side loading of the trays. Hence, a system as shown in FIG. 1A must be designed to be at least 18 inches wide on each side of the common wall, wherein the wall itself needs to be at least a foot wide to allow sufficient room for maneuvering the trays from one side of the wall to the other and to provide sufficient separation. Accordingly, a typical system as shown in FIG. 1A needs to be almost five feet wide to accommodate proper tray transportation.

FIG. 1B shows a side view of the system shown in FIG. 1A. As shown in FIG. 1B, the tray carriers 2 may be a multi-stacked receptacle for carrying multiple trays one on top of another. By employing a multi-stacked tray carrier system, the system of FIG. 1B can transport more trays at the same time, thereby potentially reducing the length of the conveyor system while maintaining or even increasing the load capacity of the system.

The system shown in FIGS. 1A and 1B is a lateral movement system in which the trays are moved laterally from one location to another location. The system of FIGS. 1A and 1B has a disadvantage in that the dishwashing room, or otherwise known as the “wet area,” must be located on the same floor as the dining area, since the trays or carriers can only be moved laterally. As a result, the dining area of the cafeteria or the restaurant must be reduced to accommodate the wet area, lowering the maximum capacity of the cafeteria or the restaurant.

### SUMMARY OF THE PRESENT INVENTION

The present invention is directed to a vertical displacement conveyor system for collecting and transporting the food trays from a drop-off area or location to a receiving area using vertical displacement of the food trays along the way.

The present invention offers the advantage of the ability to locate the wet area on a different vertical elevation or even a different floor than the dining area to thereby maximize the dining area or wet area of a cafeteria or a restaurant. Another aspect of the preferred embodiment of the present invention maintains or even increases the capacity of the conveyor system while at the same time minimizing the floor space requirements, or indeed even reduce the floor space requirement, for installing the system.

In accordance with an alternative embodiment of the present invention, the wet area are located on the same level as the dining area, but through the use of vertical displacement of the tray carriers in an “over and under” configuration, the total size of the tray transportation system maybe reduced.

In accordance with yet another embodiment of the present invention, objects such as bottles may be transported in a vertical manner for display purposes using carriers of different construction. The different embodiments of the present invention are discussed in detail below.

### BRIEF DESCRIPTION OF THE DRAWINGS

FIG. 1A illustrates a top view of a lateral displacement conveyor system for transporting objects.

FIG. 1B illustrates a side view of the lateral displacement conveyor system of FIG. 1A.

FIG. 2A illustrates a front view of a vertical displacement conveyor system in accordance with a preferred embodiment of the present invention.

FIG. 2B illustrates a side view of the preferred embodiment of FIG. 2A.

FIG. 2C illustrates a top view of the preferred embodiment of FIG. 2A.

FIGS. 2D(1), 2D(2) and 2D(3) illustrate a multi-floor floor plan incorporating the vertical displacement conveyor system in accordance with the preferred embodiment of the present invention.

FIG. 2E illustrates a front-view of one embodiment of an “over and under” configuration.

FIG. 2F illustrates a side view of the embodiment of FIG. 2E.

FIG. 2G illustrates different drive options.

FIGS. 3A(1), 3A(2), 3A(3), 3A(4), 3A(5), 3A(6), 3A(7), 3A(8), 3A(9), 3A(10), 3A(11), 3A(12), 3A(13), 3A(14) and 3A(15) illustrate various views of a vertical displacement conveyor system in accordance with an alternative embodiment of the present invention.

FIG. 3B illustrates a front view of the vertical displacement conveyor system in accordance with the alternative embodiment.

FIG. 3C illustrates a rear view of the vertical displacement conveyor system in accordance with the alternative embodiment.

FIG. 3D illustrates a side view of the vertical displacement conveyor system in accordance with the alternative embodiment.

FIG. 3E illustrates a carrier employed in the vertical displacement conveyor system of the alternative embodiment.

FIG. 3F illustrates the internal construction of the vertical displacement conveyor system of the alternative embodiment.

FIG. 3G illustrates a front view of the frame construction of the vertical displacement conveyor system of FIG. 3F.

FIG. 3H illustrates a top view of the frame construction of the vertical displacement conveyor system of FIG. 3F.

FIG. 3I illustrates a side view of the frame construction of the vertical displacement conveyor system of FIG. 3F.

FIG. 3J illustrates a cross-sectional view of the frame of the vertical displacement conveyor system of FIG. 3G along the A-A line.

FIG. 3K illustrates a cross-sectional view of the frame of the vertical displacement conveyor system of FIG. 3G along the B-B line.

FIG. 3L illustrates a cross-sectional view of the frame of the vertical displacement conveyor system of FIG. 3G along the C-C line.

FIG. 3M illustrates a cross-sectional view of the frame of the vertical displacement conveyor system of FIG. 3H along the D-D line.

### DETAILED DESCRIPTION OF THE PREFERRED EMBODIMENTS

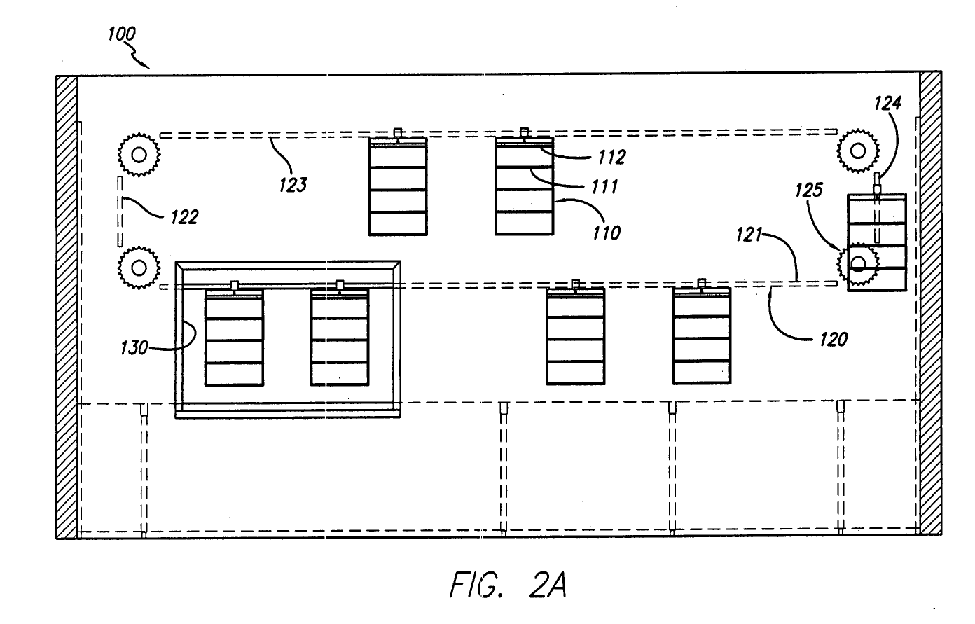

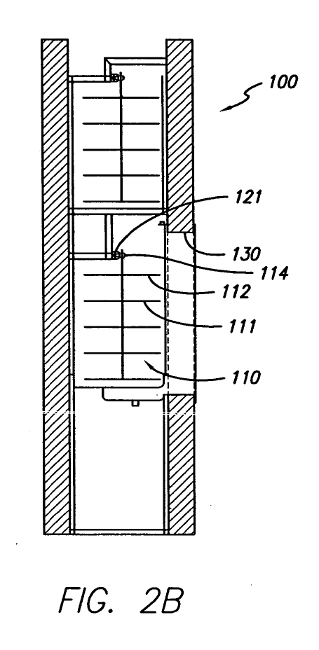

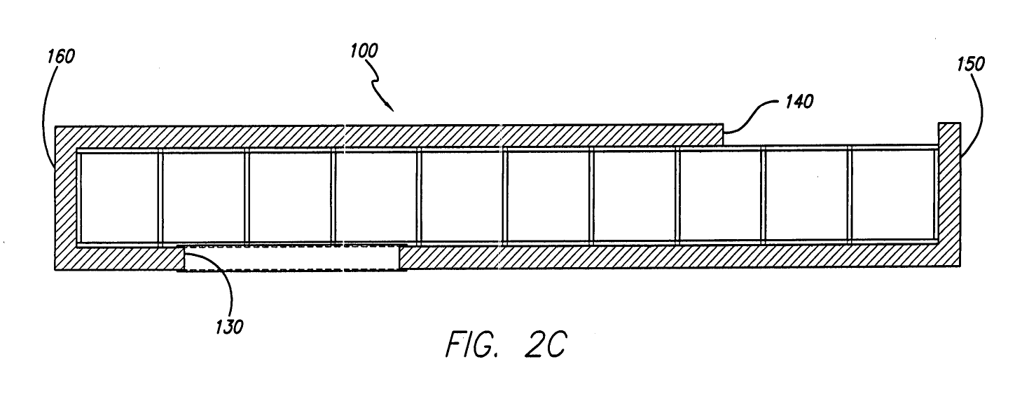

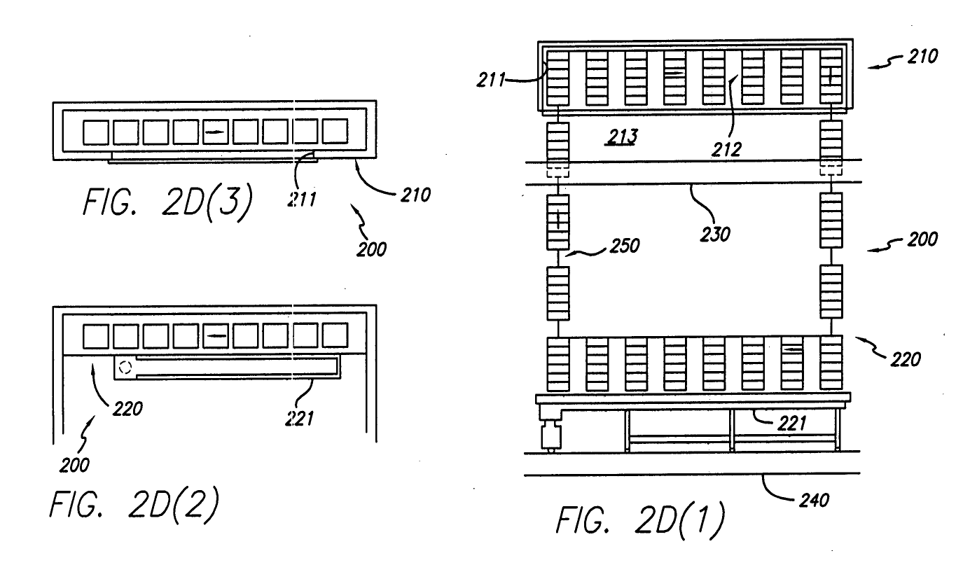

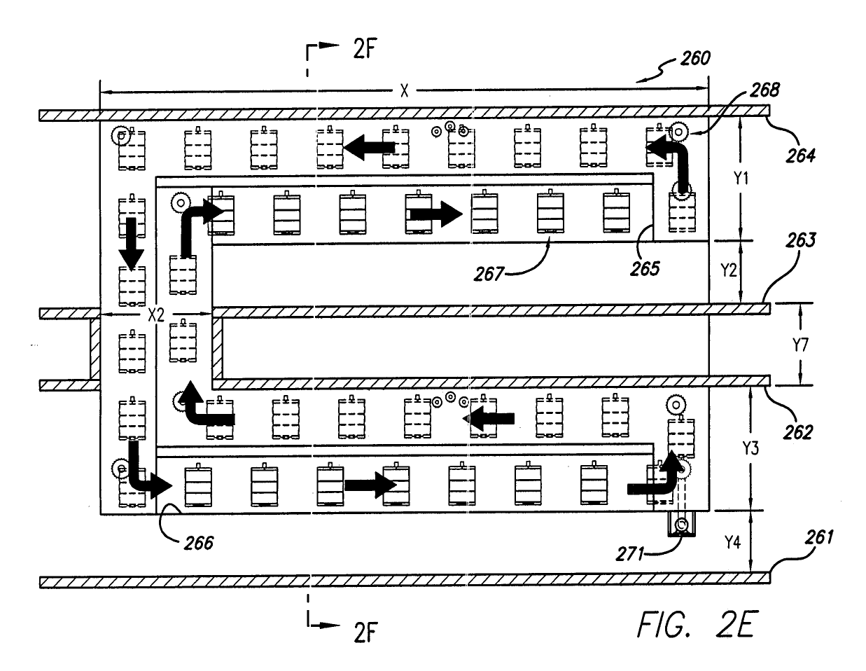

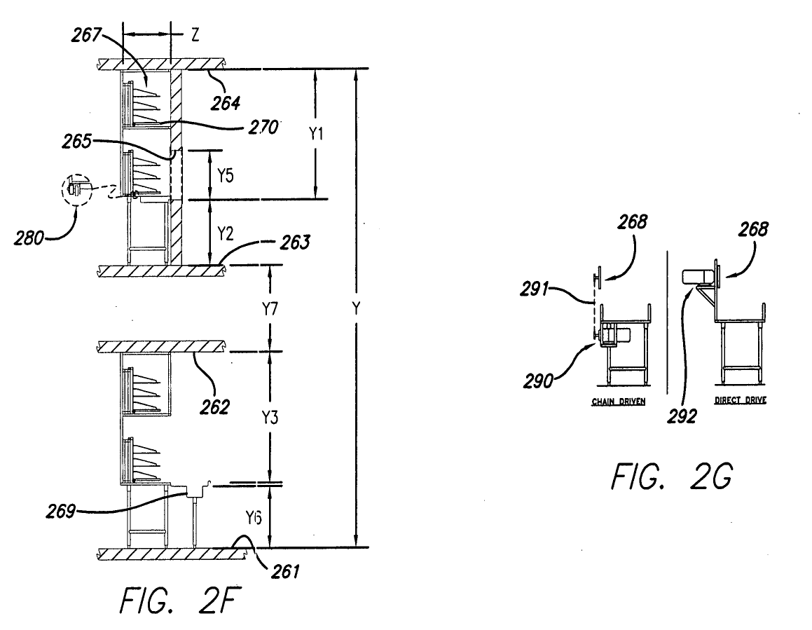

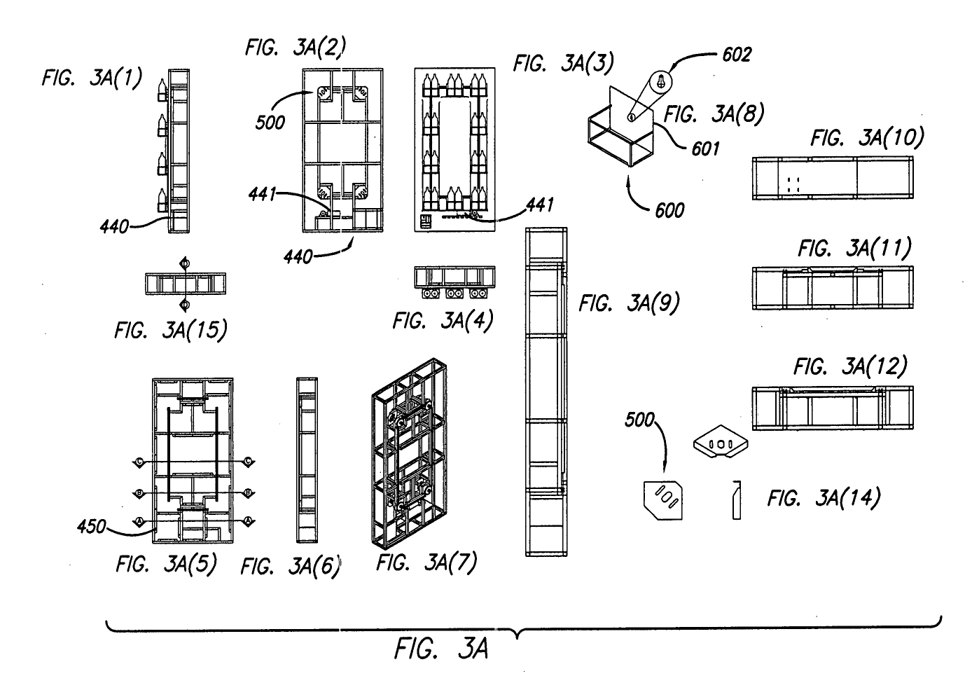

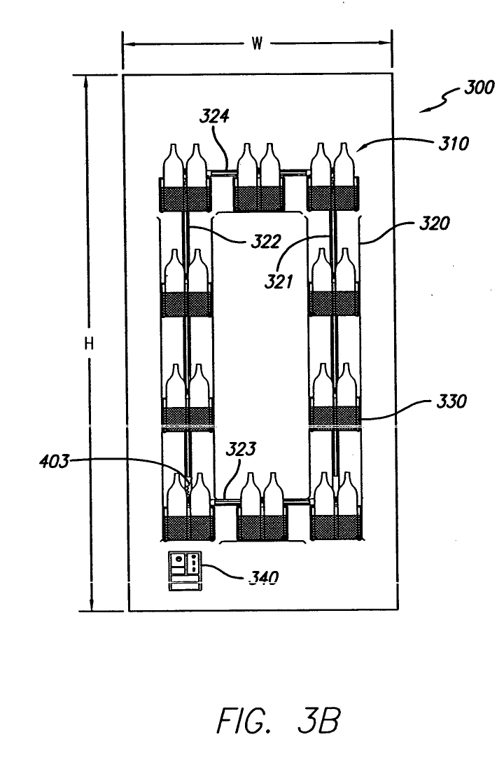

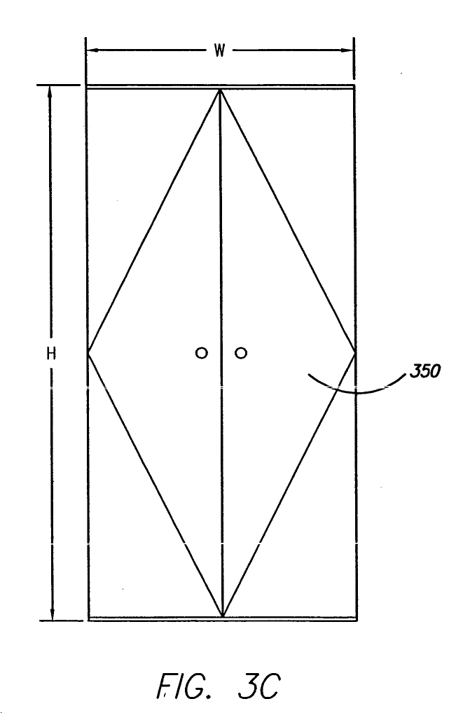

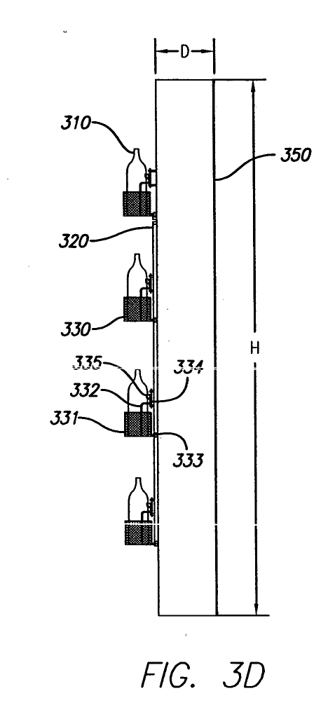

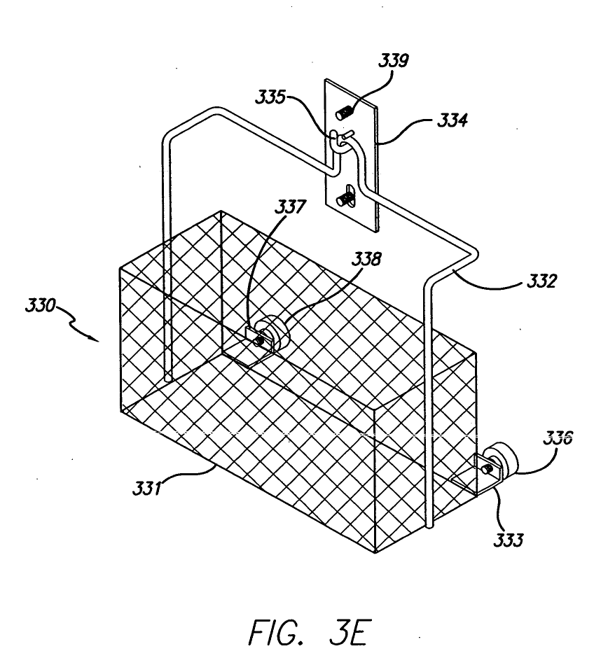

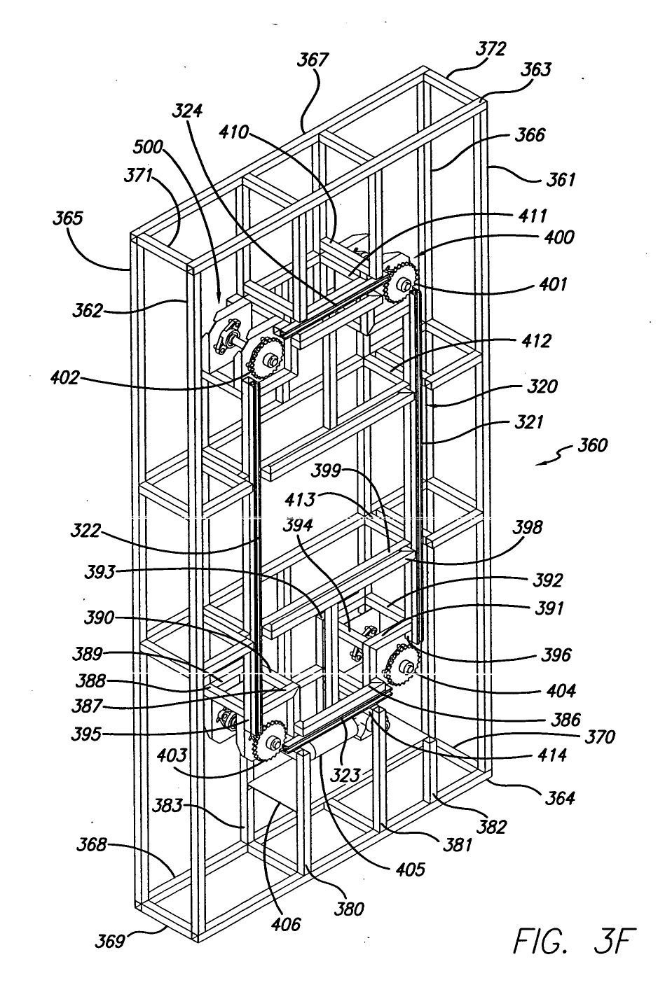

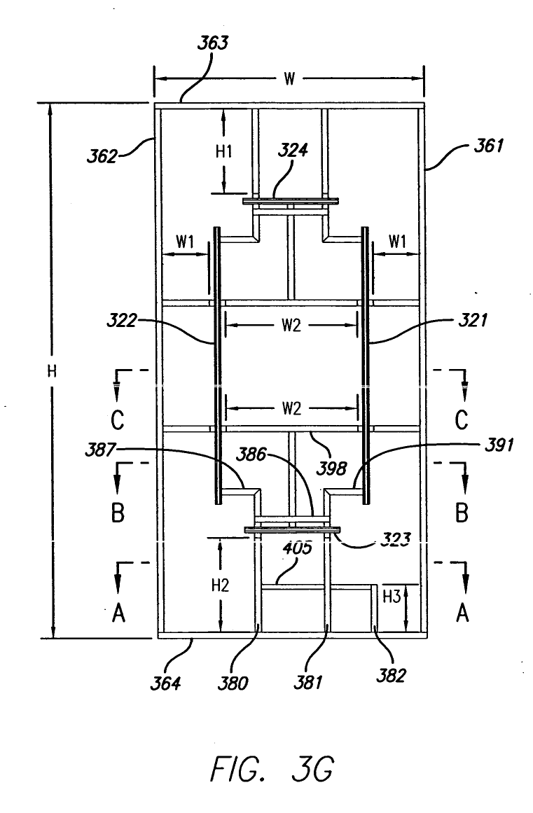

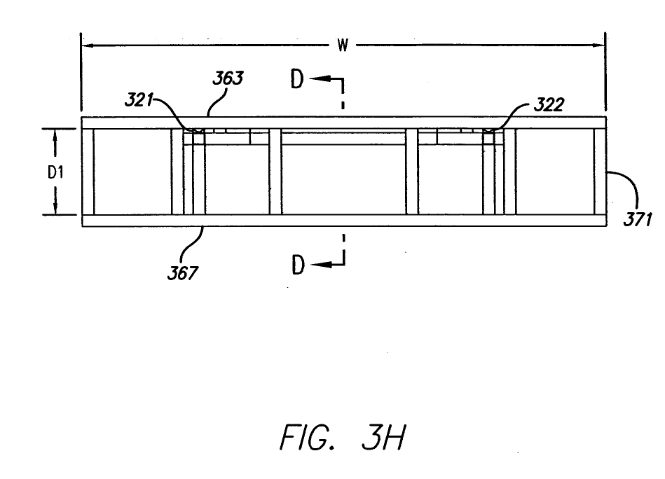

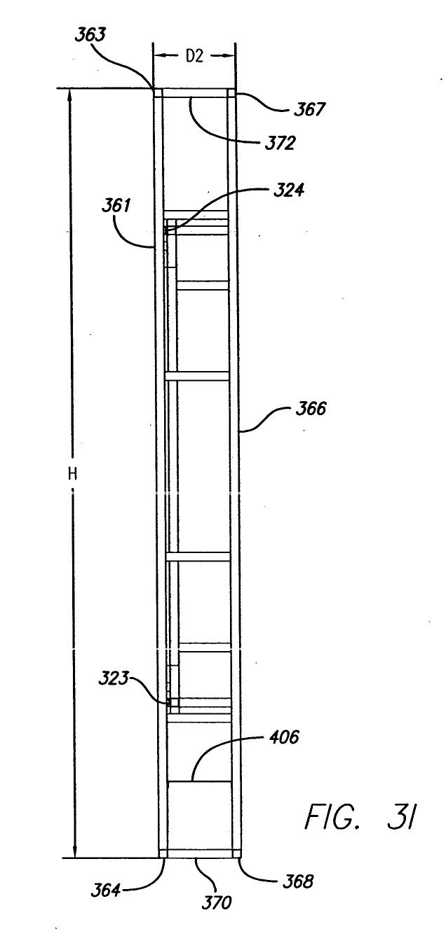

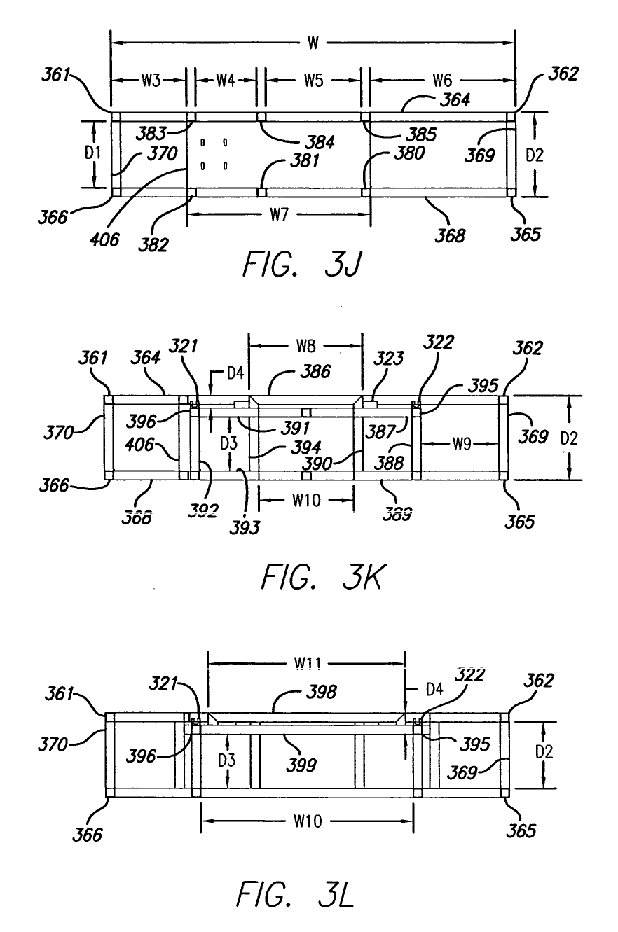

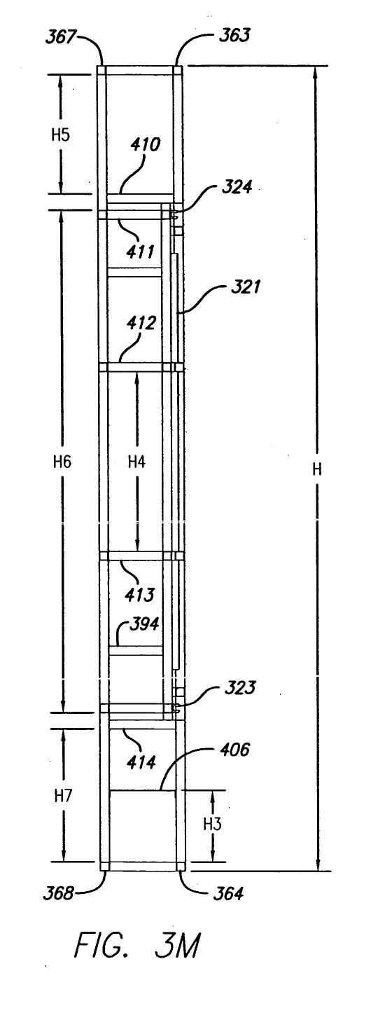

Detailed descriptions of the preferred embodiments will now be provided with references to FIGS. 2A-3M.

FIG. 2A illustrates a front view of a vertical displacement conveyor system 100 in accordance with a preferred embodiment of the present invention. As shown in FIG. 2A, carriers 110 are preferably attached to a transporting mechanism 120 of the conveyor system that transports the carriers 110 both laterally and vertically, in either a clockwise or counterclockwise direction. The transporting mechanism 120 comprises a group of gears or sprockets 125 that are placed throughout the system. FIG. 2A illustrates four gears placed at the four corners of the system. The gears are linked through a chain which is guided through a series or rails or guides 121, 122, 123 and 124. The carriers 110 are coupled to the chain, such as with a bolt or pin 114 as illustrated in FIG. 2B. When the gears are driven by a motor (not illustrated in FIG. 2A), the chain is correspondingly driven along the path defined by the gears and guides, thereby driving the carriers 110 along the path.

In a self-service cafeteria environment, a patron of the cafeteria can drop off trays into one of the carriers 110 that pass by the drop-off window 130, after which the carriers are moved along the conveyor system 100 to a receiving area for off loading before returning to the drop-off window. FIG. 2B shows a side view of the preferred embodiment. As seen in FIG. 2B, the carriers 110 are preferably made of multiple receptacles such as 111 and 112 stacked vertically for carrying multiple trays. By using multiple receptacles, each carrier can carry multiple number of trays and therefore increase the carrying capacity of the conveyor system.

FIG. 2C shows a top view of the vertical displacement conveyor system in accordance with the preferred embodiment. As can be seen from the top view, a receiving window 140 is preferably located on a side of the conveyor system opposite that of the drop-off window 130. However, the location of the receiving window 140 can also be located on the same side as the drop-off window 130, or even on the side walls 150 and 160 of the conveyor system 100. Moreover, the location of the receiving window 140 and the drop-off window 130 can be located on either the same vertical elevation or different vertical elevation, even different floors of a building. It should be understood that the location of both the drop-off window 130 and the receiving window 140 can be however located to best suit the needed application or space restriction.

FIGS. 2D(1), 2D(2) and 2D(3) show an implementation of the preferred embodiment of the present invention. As shown in FIG. 2D(1), the vertical displacement conveyor system 200 is installed such that the drop-off area 210 and the receiving/wet area 220 are located on different floors 230 and 240 respectively. Specifically, the drop-off area 210 of the system 200 shown in FIG. 2D(1) is located on a floor 230 above the receiving/wet area 220 of the system. A patron may place a tray into one of the carriers 212 passing through the drop-off window 211 which is elevated by a stub wall or panel enclosure 213, after which the carrier 212 travels along the conveyor transportation mechanism 250 in a clockwise direction towards the receiving area 220 located on a floor 240 below. The trays may be off loaded from the carriers 212 to dish table 221 at the receiving area 220 downstairs from the drop-off area 210, after which the carriers 212 travel back up towards the drop-off area 210. The conveyor transportation mechanism 250 may be operated so that the carriers 212 travel continuously, or intermittently with occasional pauses. FIG. 2D(2) shows a top view of receiving area 220 of the conveyor system 200. FIG. 2D(3) shows a top view of the drop off area 210 of the conveyor system 200.

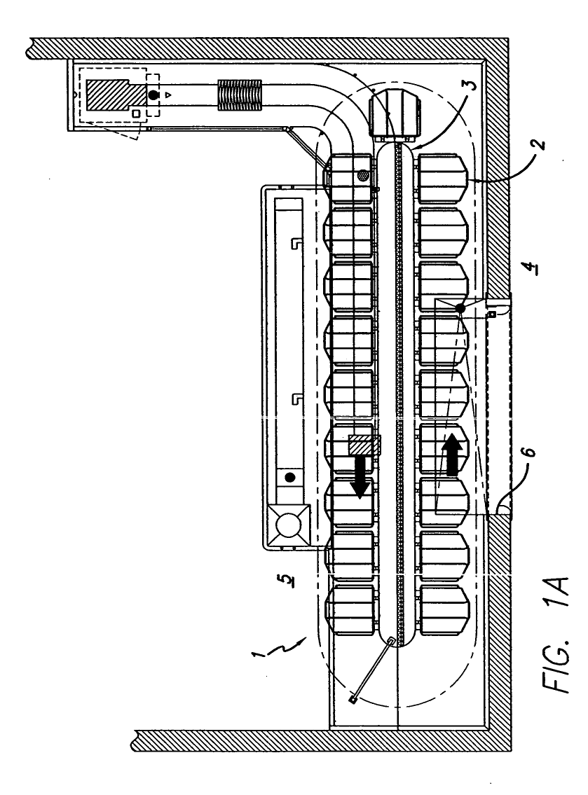

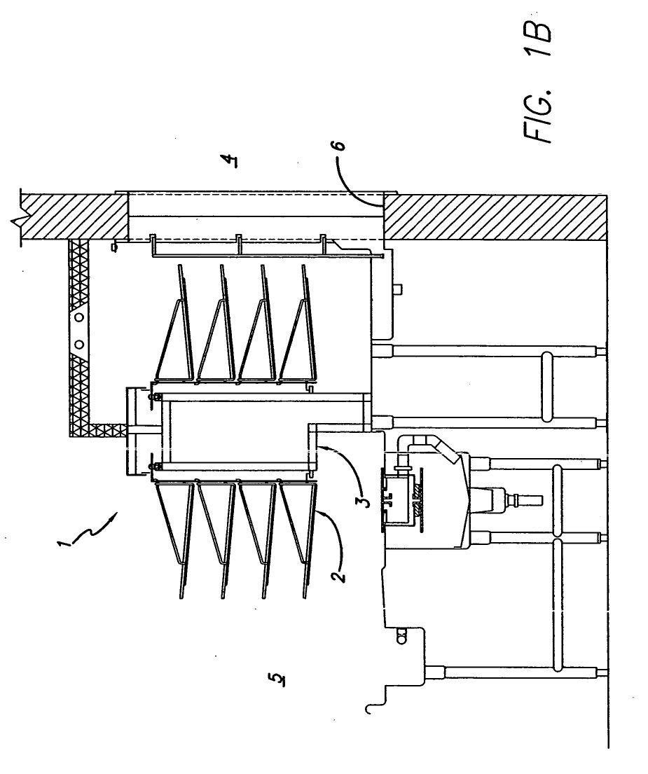

As discussed above, a typical cafeteria food tray measures about 18 inches by 14 inches. In a conventional lateral displacement conveyor system such as the one shown in FIG. 1A, where the trays are loaded side ways into the system, the apparatus must have a minimum width of around 60 inches to accommodate the trays on both sides and the common wall in between. The preferred embodiment of the present invention, on the other hand, allows the trays to be returned above or below (as shown in FIG. 2B), and hence only requires a maximum width of around 34 inches. Of course, these measurements are only cited for illustration purposes, and should not be interpreted as limitations.

FIGS. 2E and 2F illustrate one embodiment of an over-under configuration. Such a configuration can be used when a rectangular path is not available due to space constraints or other constraints. The vertical conveyor system 260 of FIGS. 2E and 2F transports carriers, such as carrier 267. The carrier 267 can be a multi-tray carrier as illustrated in FIG. 2F. Carrier 267 has a counterweight 270 to ensure stability as it is driven along the vertical conveyor system. A guide mechanism illustrated at 280 at the bottom portion of the carrier further ensures stability as well as guide the carrier along its path.

The vertical conveyor system 260 transports the carriers between a lower level and an upper level. The lower level is defined by floor 261 and ceiling 262. The upper level is defined by floor 263 and ceiling 264. The distance Y7 between the floor 263 of the upper level and the ceiling 262 of the lower level can be 4 feet.

Customers or patrons can place trays or other objects in a carrier 267 at window 265. The window 265 can be placed at a height Y2 of 3 feet above floor 263. The height Y5 of the window, itself, can be 2 feet, 3 inches as illustrated in FIG. 2F while the height Y1 to the ceiling 264 can be six feet.

The conveyor system then transports the carrier 267 horizontally along the window 265 in the direction of the arrow of FIG. 2E. As it nears the right side of the system, the carrier 267 is transported vertically up and then horizontally along an upper path as indicated by the arrow in FIG. 2E. The horizontal and vertical movements are achieved through a series of gears or sprockets 268 placed throughout the conveyor system. Each carrier is coupled to a chain guided by a rail or guide and driven by the gears. The gears in turn are driven by a motor 271. The motor 271 can drive one or more gears through a chain as illustrated in FIG. 2E. FIG. 2G also illustrates a side view of motor 290 driving a gear 268 through a chain 291. FIG. 2G also illustrates another embodiment in which the gear 268 is directly driven by a motor 292 without a chain.

As the carrier 267 nears the left side of the upper level, it transported vertically down toward the lower level along a vertical path as indicated by the arrow. As the carrier heads down vertically, other carriers are heading up vertically along an adjacent path. The width X2 of the two paths can be five feet, six inches. The carrier 267 then emerges at the lower level through receiving area having a receiving window 266. The receiving window 266 can be placed at a height Y4 of 3 feet above floor 261. The height Y3 to the ceiling 262 can be six feet. Adjacent to the receiving area is a dish table 269 as illustrated in FIG. 2F, having a height Y6 of 2 feet, 10 inches.

As the carrier 267 travels along the receiving area, an individual can unload the trays or other objects from carrier 257. The carrier 267 continues horizontal until it reaches the right side of the system, upon which is travels vertically as indicated by the arrow. The carrier 267 then travels along a horizontal and vertical path as it returns to window 265 to be loaded with trays or other objects.

It should be understood to one skilled in the art that different types of motors and drive mechanism can be used to effect the transport mechanism mentioned above.

FIG. 3A illustrates various views of a vertical displacement conveyor system in accordance with an alternative embodiment of the present invention.

As shown in FIG. 3B, the vertical displacement conveyor system 300 can also be used to transport other types of objects such as bottles or liquid containers 310. The containers 310 are stored in carriers 330 and transported along a rectangular path. The path is defined by four internal rails 321, 322, 323 and 324 with gears or sprockets at each corner. Only gear 403 is illustrated in FIG. 3B while FIG. 3F illustrates all four gears. A motor (such as motor 441 illustrated in FIGS. 3A(3) and 3A(4) drives the carriers 330 along the internal rails and gears through a chain (also not illustrated). The operation of the system is controlled by control panel 340. The control panel can be mounted in a mounting bracket such as bracket 441 in FIGS. 3A(1) and 3A(2).

To guide the carriers 330 during transportation, six guide rails 320 are positioned to be adjacent to the sides or bottom of the carriers 330. As discussed below with respect to FIGS. 3D and 3E, each of the carriers 330 has corresponding guide elements that follow the guide rails 320.

The height H and width W of the system 300 can be 9 feet, 4 inches and 4 feet, 7 inches respectively. The depth D of the system 300 can be 1 foot as illustrated in FIG. 3D. An advantage offered by this alternative embodiment is the ability to store multiple bottles of liquid while minimizing the horizontal space required for storing the bottles. At the same time, this alternative embodiment provides the advantage of displaying the bottles in an aesthetically unique manner. Such conveyor systems may be used at places such as nightclubs or bars that may benefit from aesthetic display of alcoholic beverage containers. FIGS. 3C and 3D illustrate a rear view and side view of the alternative embodiment, respectively. As illustrated in both figures, the rear of the conveyor system 300 can be enclosed by sliding doors 350. The sliding doors provide access to the internal mechanisms and structure of the system. For example, as illustrated in FIG. 3A(2), a user can access the motor 441 or the control panel 340 supported by mounting bracket 440. Access is also available to brackets 500 that hold the gears or sprockets of the system as discussed below.

FIG. 3E shows an isometric view of carrier 330 of the conveyor system 300 in accordance with the alternative embodiment. The carrier 330 comprises a basket 331. The basket is designed to securely hold at least one container, such as a bottle. The basket 331 is connected to a metal handle 332. The metal handle 332 is shaped to allow the placement of containers 310 in the carrier 330 while allowing the handle to be hooked to a connection 335 extending from bracket 334. Bracket 334, in turn, is coupled to the transport path of system 300 in a manner that allows the carrier to be transported. For example, the bracket 334 can be coupled to bolts 339 which in turn are coupled to the chain driven along internal rails 321, 322, 323 and 324 and gears. It should be noted that carrier 330 can be shaped and connected to the transport system in other ways. For example, FIG. 3A(8) illustrates a carrier 600 without a metal handle. Instead, a solid back 601 has an opening 602 for a bolt that, in turn, can be coupled to a chain.

The carrier 330 further comprises guide elements 336 and 338 connected to the basket 331 by brackets 333 and 337 respectively. The guide elements follow the guide rails 320 as illustrated in FIG. 3D to keep the carrier on the transport path.

FIGS. 3F through 3M illustrate different views and cross-sectional views of the structural support and motor mechanism of the alternative embodiment.

In FIG. 3F, the structural support comprises of a plurality of rectangular beams 360 connected together to form a frame. The structural support on the front or rail (320) side is defined by vertical beams 361 and 362 connected by horizontal beams 363 and 364 to form a front or rail side rectangular frame. On the rear side, the structural support is defined by vertical beams 365 and 366 connected by horizontal beams 367 and 368 to form a rear side rectangular frame. The front or rail side rectangular frame and the rear side rectangular frame are connected by a series of shorter beams, including beams 369, 370, 371 and 372 to form a volumetric rectangular space. The frame can have cover supports 450 as illustrated in FIG. 3A(5).

The motor mechanism 400 is positioned within the rectangular space. The motor mechanism comprises four gears 401, 402, 403 and 404 and a motor 405 (not fully illustrated) supported by motor base bracket 406. Each gear comprises a gear element, a shaft connected to the gear element and a bracket 500 connected to a shaft and a plate for positioning and supporting the gear element. Further views of an exemplary idler bracket are provided in FIGS. 3A(2) and 3A(14). The motor 406 drives the carriers along the internal rails 321, 322, 323 and 324 and gears 401, 402, 403 and 404.

FIG. 3G shows a front view of the frame of FIG. 3F. FIG. 3G illustrates the front or rail side rectangular frame defined by beams 361, 362, 363 and 364. As further illustrated in FIG. 3G, the internal rails 321, 322, 323 and 324 are positioned approximately at the center of the rectangular frame. The distance H3 from rail 364 to motor base bracket 406 can be 10 inches.

Although not shown in FIG. 3G, the internal rails 321, 322, 323, and 324 are positioned within the volumetric rectangular frame. The frame has cut-out sections in which a given internal rail is placed. The distance H1 from the inner edge of beam 363 to a cut-out above internal rail 324 can be 1 foot, 5¾ inches. The distance H2 from the inner edge of beam 364 to a cut-out below rail 323 can be 1 foot, 7¾ inches. Similarly, the distance W1 from the inner edges of vertical beams 361 and 362 to cut-outs on the outer sides of rails 321 and 322 respectively can be 9½ inches. The distance W2 between the cut-outs on the inner sides of rails 321 and 322 can be 2 feet, 3 inches.

FIG. 3H illustrates a top view of the frame of FIG. 3F. FIG. 3H illustrates the volumetric rectangular frame is formed in part by connecting beams 363 and 367 to beams 371 and 372. The distance D1 between the inner edges of beams 363 and 367 can be 9¼ inches.

As discussed above with respect to FIG. 3G, internal rails 321, 322, 323 and 324 are positioned within the volumetric rectangular frame. FIG. 3H illustrates this feature with respect to rails 321 and 322. Rails 321 and 322 are positioned internal to beam 363.

FIG. 31 illustrates a side view of the frame of FIG. 3F. This view shows that the right side of the volumetric rectangular frame is formed by connecting beams 361, 363, 364, 366, 367, 368, 370 and 372 together. The distance D2 from the outside edge of beam 363 to the outside edge of beam 367 can be 11¾ inches. This is ¼ inch less than the distance D illustrated in FIG. 3D, because it does not include the depth of sliding doors 350.

As discussed above with respect to FIG. 3G and FIG. 3H, internal rails 321, 322, 323 and 324 are positioned within the volumetric rectangular frame. FIG. 31 illustrates this feature with respect to rails 323 and 324. Rails 323 and 324 are positioned internal to beam 361.

FIG. 3J illustrates a top cross-sectional view of the frame of FIG. 3G along the A-A line of FIG. 3G. The motor base bracket 406 is not positioned to be equidistant from beams 369 and 370. Rather, the distance W3 between the outer edge of beam 370 and one edge of the bracket 406 can be 10¼ inches while the distance W6 between the outer edge of beam 369 and the other edge of bracket 406 can be 1 foot, 7¾ inches. The bracket 406 is supported by six vertical beams 380, 381 382, 383, 384 and 385. Beams 380 and 385 do not extend vertically above bracket 406 as illustrated in FIG. 3F. The length W7 of the bracket 406 can be 2 feet, 1 inch. As illustrated in FIG. 3J and FIG. 3G, the supporting beams are not placed at equal distances along the bracket 406. The distance W4 from the inner edge of beam 383 to one edge of beam 384 can be 8¼ inches. In contrast, the distance W5 from the other edge of beam 384 to the inner edge of beam 385 can be 1 foot, 1 inch.

FIG. 3K illustrates another top cross-sectional view of the frame of FIG. 3G along the B-B line of FIG. 3G. Rails 321 and 322 are connected to beams 396 and 395 respectively. Beam 396 supporting rail 321 is connected directly or indirectly to a square-shaped group of beams 391, 392, 393 and 394. Similarly, beam 395 supporting rail 322 is connected directly or indirectly to a square-shaped group of beams 387, 388, 389 and 390.

Each of the square-shaped group of beams provides the top cover of a partial cube of beams that support and cover the gears 403 and 404 as illustrated in FIG. 3F. The dimensions and placement of the square-shaped group of beams is illustrated in FIG. 3K. The internal depth D3 of each square-shaped group can be 7½ inches. Each square-shaped group of beam can be positioned to be 10½ inches (W9 in FIG. 3K) from the inner edges of side beams 369 and 370. The outer and inner distances W8 and W10 between the two group of beams can be 1 foot, 3½ inches and 1 foot, 1 inch respectively.

FIG. 3K highlights the internal placement of rails 321, 322 and 323 within the rectangular volumetric frame. As discussed above with respect to FIG. 3G, the internal placement is achieved through cut-out portions in the external rectangular volumetric frame. FIG. 3K illustrates the depth of the cut-out portion vis-à-vis horizontal rail 323. The distance D4 between the outer edge of the volumetric frame and the back edge of rail 323 can be 1¾ inches.

FIG. 3L illustrates another top cross-sectional view of the frame of FIG. 3G along the C-C line of FIG. 3G. FIG. 3L illustrates that the internal rails, such as 321 and 322, remain internal to the rectangular volumetric frame in the region between the lower gears 403 and 404 and the upper gears 401 and 402 (illustrated in FIG. 3F). With internal rails, the frame has a series of beams that do not span the entire width of the frame. For example, beam 398 has a width W11 of 2 feet, 3 inches, which is less than half of the entire width W of the frame.

FIG. 3L also illustrates that support for the beams 395 and 396 which support the internal rails is provided by horizontal beam 399. Beam 399 has a longer width than beam 398. The width W10 of beam 399 can be 2 feet, 5 inches.

FIG. 3M illustrates a side cross-sectional view of the frame of FIG. 3H along the D-D line of FIG. 3H. FIG. 3M illustrates that a series of cross-beams, such as beams 410, 412, 413 and 414 are used to support the frame. These beams, however, are not positioned at equal distances from the top of the frame to the bottom of the frame. The distance H5 from the top of the frame to the top edge of beam 410 can be 1 foot, 4½ inches while the distance H7 from the bottom of the frame to the bottom edge of beam 414 can be 1 foot, 6½ inches. The distance H4 between beams 412 and 413 can be 2 feet, 1 inch.

FIG. 3M illustrates that internal rails 321, 323 and 324 within the volumetric rectangular frame. The vertical distance H6 between the outer edges of the beams supporting the internal rail 323 and 324 is 5 feet, 10 inches. As discussed above, each of the gears 401, 402, 403 and 404 are positioned within a partial cube of beams. FIG. 3M illustrates one view of these partial cubes of beams. For example, beam 394 discussed with respect to FIG. 3K is illustrated as comprising one of beams in the group for gear 404, while beam 411 comprises one of the beams in the group for gear 401.

It should be understood to one skilled in the art that multiple methods of construction may be employed to achieve the same functionality and result of the alternative embodiment.

Although the present invention has been fully described in connection with the embodiments thereof and with reference to the accompanying drawings, it is to be noted that various changes and modifications will become apparent to those skilled in the art. Such changes and modifications are to be understood as being included within the scope of the present invention as defined by the claims.

1. A system for transporting a plurality of food-carrying trays, said system comprising:
a plurality of carriers, each carrier capable of holding at least one food-carrying tray;
a drop-off area for loading at least one food-carrying tray in a carrier, said drop-off area at a first elevation;
a receiving area for unloading at least one food-carrying tray from a carrier, said receiving area at a second elevation;
a conveyor for vertically and horizontally moving said plurality of carriers between the drop-off area and the receiving area, said conveyor comprising at least one vertical portion and at least one horizontal portion such that the movement of each carrier is confined to a planar path defined by the vertical and horizontal portions.

2. The system of claim 1 wherein the vertical portion spans the distance between the first elevation and the second elevation.

3. The system of claim 1 wherein the first elevation and the second elevation are the same.

4. The system of claim 1 wherein the drop-off area and the receiving area are positioned on different sides of the conveyor.

5. The system of claim 1 wherein each carrier comprises a plurality of receptacles, each receptacle capable of holding a tray.

6. The system of claim 1 wherein the conveyor further comprises a plurality of gears and a motor.

7. The system of claim 1 wherein the planar path is rectangular.

8. An apparatus for transporting one or more objects between a drop-off area and a receiving area, said apparatus comprising:
a plurality of carriers, each carrier capable of holding at least one object; and
a conveyor for vertically and horizontally moving said plurality of carriers between the drop-off area and the receiving area, said conveyor comprising at least one vertical portion and at least one horizontal portion such that the movement of each carrier is confined to a planar path defined by the vertical and horizontal portions.

9. The apparatus of claim 8 wherein each carrier comprises a plurality of receptacles, each receptacle capable of holding an object.

10. The apparatus of claim 9 wherein each receptacle is substantially rectangular so as to be capable of holding a food-carrying tray.

11. An apparatus for transporting and displaying one or more objects, said system comprising:
a plurality of carriers, each carrier capable of holding at least one object;
a first and second plurality of beams, said first plurality of beams forming an external frame;
a conveyor for vertically and horizontally moving said plurality of carriers, said conveyor comprising a plurality of rails connected to the second plurality of beams, said plurality of rails comprising at least one vertical rail and at least one horizontal rail such that the movement of each carrier is confined to a planar path defined by the vertical and horizontal rails.

12. The system of claim 111 further comprising a plurality of guide rails for guiding the plurality of carriers.

13. The apparatus of claim 12 wherein each carrier comprises a basket for holding and displaying one or more objects.

14. The apparatus of claim 13 wherein the basket further comprises a handle connected to the basket for coupling to the conveyor and at least one guide element connected to the basket for following at least one guide rail.

15. The apparatus of claim 11 wherein the second plurality of beams are positioned within the external frame.

16. The apparatus of claim 11 wherein the conveyor further comprises a plurality of gears and a motor.

17. The apparatus of claim 16 wherein each gear is positioned between at least one vertical rail and one horizontal rail.

18. The system of claim 11 wherein the object is a bottle.
